(19) United States
(12) Patent Application Publication
(10) Pub. No.: US 2026/0176462 A1
(43) Pub. Date: Jun. 25, 2026

(54) POWDER COATING COMPOSITION

(71) Applicant: KCC CORPORATION, Seoul (KR)

(72) Inventors: Hyuk JEONG, Yongin-si, Gyeonggi-do (KR); Jin Hoi KIM, Hwaseong-si, Gyeonggi-do (KR); Jin CHO, Pyeongtaek-si, Gyeonggi-do (KR); Jong Yun PARK, Yongin-si, Gyeonggi-do (KR); Jin Seok LEE, Yongin-si, Gyeonggi-do (KR); Sang Ju PARK, Namyangju-si, Gyeonggi-do (KR); Seung Yeob CHOI, Hwaseong-si, Gyeonggi-do (KR)

(21) Appl. No.: 19/121,429

(22) PCT Filed: Nov. 1, 2023
(86) PCT No.: PCT/KR2023/017253

§ 371 Date: Apr. 16, 2025

(30) Foreign Application Priority Data
Nov. 22, 2022 (KR) 10-2022-0157149

(51) Int. Cl. C08L 63/00; C08G 59/18; C08G 59/22; C08G 59/40; C08G 59/50; C08G 59/62; C08L 83/04; C09D 163/00

(52) U.S. Cl. CPC C08L 63/00; C08G 59/184; C08G 59/226; C08G 59/40; C08G 59/504; C08G 59/621; C08L 83/04; C09D 163/00

(57) ABSTRACT

Provided is a powder coating composition that offers excellent flexibility, appearance, corrosion resistance, and the like, without reducing the glass transition temperature of a cured product. Specifically, the powder coating composition maintains excellent adhesion, thermal stability, and mechanical properties of epoxy-based coatings while overcoming the limitation of brittleness, thereby providing excellent flexibility, appearance, corrosion resistance, and the like, without reducing the glass transition temperature of a final cured product. The powder coating composition may form a coating film exhibiting excellent heat resistance, adhesion, bending properties, and corrosion resistance even in a high-temperature/high-pressure environment. Therefore, the powder coating composition may be used as a powder coating for pipe required for transporting high-temperature fluids.

### TECHNICAL FIELD

The present invention relates to a powder coating composition which provides excellent flexibility, appearance, corrosion resistance, and the like, without reducing the glass transition temperature of a cured product.

### BACKGROUND ART

Pipelines for oil extraction and transportation, buried underground or underwater, are coated with coating materials for corrosion prevention and durability enhancement. To prevent pipe corrosion caused by harsh conditions such as microcurrents and moisture in burial environments like overground, underground, and underwater, coating materials are applied to the interior and exterior of pipes, and long-term property management standards for coating materials required in the relevant industry are gradually being tightened. In particular, the depletion of underground resources leads to more frequent extraction in harsh environments, resulting in increased mining depths and more severe burial conditions, and accordingly, there is a continuous demand for improvements in the thermal, chemical, and mechanical properties of coatings for pipe to protect the pipes from corrosion at high temperatures, and research on coatings that satisfy these properties is also ongoing. For example, U.S. Pat. No. 5,407,978 discloses a powder coating for pipes that includes an aliphatic polyol modified epoxy resin and a phenolic curing agent.

In addition, along with corrosion resistance and heat resistance, flexibility is also required in pipe interior and exterior coating materials to protect a basis material from impacts and scratches. To provide flexibility to powder coatings, a technology using toughening agents such as rubber modified resin types, core-shell resin types, and block copolymer types has been proposed. However, coating technologies including typical toughening agents induces a reduction in the glass transition temperature of a cured product. Accordingly, there is a need for the development of a powder coating including a toughening agent that provides superior flexibility without reducing the glass transition temperature of a cured product.

### INVENTION OF THE INVENTION

### Technical Problem

The present invention provides a powder coating composition exhibiting excellent flexibility, appearance, corrosion resistance, and the like, without reducing the glass transition temperature of a cured product.

### Technical Solution

A powder coating composition according to the present invention includes an epoxy resin, a silicone modified toughening agent, a curing agent, and a filler.

### Advantageous Effects

A powder coating composition according to the present invention maintains excellent adhesion, thermal stability, and mechanical properties of epoxy-based coatings while overcoming the limitation of brittleness, thereby providing excellent flexibility, appearance, corrosion resistance, and the like, without reducing the glass transition temperature of a final cured product. The powder coating composition according to the present invention may form a coating film exhibiting excellent heat resistance, adhesion, bending properties, and corrosion resistance even in a high-temperature/high-pressure environment. Therefore, the powder coating composition according to the present invention may be used as a powder coating for pipe required for transporting high-temperature fluids.

### BEST MODE FOR CARRYING OUT THE INVENTION

Hereinafter, the present invention will be described in more detail. However, the present description is not intended to limit the invention to the following content, and when necessary, various components may be modified in various manners or may be optionally used together with each other. It is to be understood that the present invention includes all changes, equivalents, and alternatives falling within the spirit and scope of the present invention.

A “weight average molecular weight” used herein is determined through typical methods known in the related art, and may be determined through, for example, a gel permeation chromatography (GPC) method.

A powder coating composition according to the present invention includes an epoxy resin, a silicone modified toughening agent, a curing agent, and a filler. The powder coating composition according to the present invention may further include additives commonly used in the related art, such as curing aids, pigments, pinhole prevention agents, and leveling agents, as needed, within a range that does not impair the inherent properties and characteristics.

### Epoxy Resin

The powder coating composition according to the present invention includes an epoxy resin. As the epoxy resin, a bisphenol A type epoxy resin, a bisphenol F type epoxy resin, a polyol modified epoxy resin, a novolac modified epoxy resin, an isocyanate modified epoxy resin, a cresol novolac epoxy resin, and the like may be used. These may be used alone or in a combination of two or more.

For example, the epoxy resin includes a bisphenol A type epoxy resin, a bisphenol F type epoxy resin, a polyol modified epoxy resin, or a mixture thereof. The bisphenol A type epoxy resin, the bisphenol F type epoxy resin, and the polyol modified epoxy resin may each have an epoxy equivalent of 200 to 1,000 g/eq, for example, 400 to 800 g/eq. When the epoxy equivalent satisfies the range described above, excellent flexibility, corrosion resistance, and manufacturing workability may be secured. When the epoxy equivalent is less than the range described above, crosslinking with a curing agent may not occur properly, which may result in reduced adhesion, and when the epoxy equivalent is greater than the range described above, excessive crosslinking with a curing agent may occur, which may result in reduced bending properties.

For example, the epoxy resin includes a novolac modified epoxy resin, a cresol novolac epoxy resin, or a mixture thereof. The novolac modified epoxy resin and the cresol novolac epoxy resin may each have an epoxy equivalent of 100 to 1,500 g/eq, for example, 200 to 800 g/eq. When the epoxy equivalent satisfies the range described above, excellent flexibility, corrosion resistance, and manufacturing workability may be secured. When the epoxy equivalent is less than the range described above, crosslinking with a curing agent may not occur properly, which may result in reduced adhesion, and when the epoxy equivalent is greater than the range described above, excessive crosslinking with a curing agent may occur, which may result in reduced bending properties.

For example, the epoxy resin includes an isocyanate modified epoxy resin. The isocyanate modified epoxy resin may have an epoxy equivalent of 100 to 1,500 g/eq, for example, 200 to 1,000 g/eq. When the epoxy equivalent satisfies the range described above, excellent flexibility, corrosion resistance, and manufacturing workability may be secured. When the epoxy equivalent is less than the range described above, crosslinking with a curing agent may not occur properly, which may result in reduced adhesion, and when the epoxy equivalent is greater than the range described above, excessive crosslinking with a curing agent may occur, which may result in reduced bending properties.

The powder coating composition according to the present invention may include 45 to 75 wt %, for example, 50 to 70 wt %, of the epoxy resin with respect to a total weight of the composition. When the content of the epoxy resin is less than the range described above, bending properties may be reduced, and when the content of the isocyanate modified epoxy resin is greater than the range described above, boiling water resistance and corrosion resistance may be reduced due to unreacted residual epoxy resin.

### Silicone Modified Toughening Agent

The powder coating composition according to the present invention includes a silicone modified toughening agent. The silicone modified toughening agent is a compound having a silicone group, a lipophilic group, and a hydrophilic group at once, and serve to improve flexibility and processability.

In general, epoxy resins have a high crosslinking density due to their structural characteristics, but this high crosslinking density induces brittleness, making the epoxy resins vulnerable to momentary impact. Therefore, when a brittle epoxy resin is applied to coatings applied onto a pipe having a curved surface, a coating film may be broken. In the present invention, the silicone modified toughening agent is mixed with the epoxy resin and then cured, thereby overcoming the brittleness of the epoxy resin.

The silicone modified toughening agent is a polymer synthesized by polymerizing an alkylene oxide polymer and silicone. For example, the silicone modified toughening agent is a polymer in which an alkylene oxide polymer is modified with polydimethylsiloxane into a pendant type, and through the modification, the toughening agent has the characteristics of silicone.

The alkylene oxide polymer, a compound with both lipophilic and hydrophilic groups, allows molecular rotation due to its structure, thus exhibiting excellent flexibility, but has relatively small bonding energy with materials due to the inclusion of organic substances, which may lead to degradation in properties such as chemical resistance and corrosion resistance. Conversely, siloxane has silicone properties of excellent heat resistance, water repellency, and weather resistance. In the present invention, a silicone modified toughening agent synthesized by polymerizing an alkylene oxide polymer and silicone is used, and the silicone modified toughening agent has the characteristics of flexibility and dispersibility of the alkylene oxide polymer, along with heat resistance, water repellency, weather resistance, and appearance characteristics resulting from the silicone modification. Consequently, the appearance, corrosion resistance, and bending properties may be improved without causing deformation and reduction in glass transition temperature, of a final cured product during film formation.

As the alkylene oxide, ethylene oxide, propylene oxide, butylene oxide, pentylene oxide, hexylene oxide, octylene oxide, and the like may be used. These may be used alone or in a combination of two or more. For example, the alkylene oxide may be an alkylene oxide having 1 to 4 carbon atoms, and in this case, the toughening agent may have further improved dispersibility.

The silicone modified toughening agent may have a silicone content of 30 to 80 wt % with respect to a total amount of the toughening agent. When the content of silicone is less than the range described above, bonding energy may decrease, resulting in reduced corrosion resistance, and when the amount of silicone modification is greater than the range described above, compatibility with the epoxy resin may be degraded to reduce dispersibility, resulting in reduced bending properties.

The silicone modified toughening agent may be a compound represented by Formula 1 below.

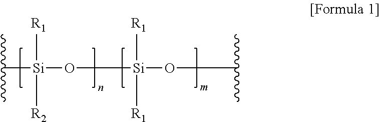

In Formula 1 above,
R₁ is —H, —CH₃, —C₆H₆, —OCH₃, —OCH₂OCH₃, or —OCH₂CH₂CH₃,
R₂ is an alkylene oxide oligomer, for example, an alkylene oxide oligomer having 2 to 8 carbon atoms,
n is an integer between 1 and 10, for example, an integer between 2 and 8, and
m is an integer between 5 and 20, for example, an integer between 8 and 15.

The silicone modified toughening agent may have a weight average molecular weight of 5,000 to 20,000 g/mol, for example 6,000 to 10,000 g/mol, and a softening point of 95 to 125° C. When the weight average molecular weight of the silicone modified toughening agent is within the range described above, a coating film may have improved bending properties, corrosion resistance, and appearance. When the weight average molecular weight of the silicone modified toughening agent is less than the range described above, corrosion resistance may be reduced, and when the weight average molecular weight of the silicone modified toughening agent is greater than the range described above, compatibility may be reduced, resulting in poor appearance. When the softening point of the silicone modified toughening agent is within the range described above, a coating film may have improved bending properties and appearance. When the softening point of the silicone modified toughening agent is less than the range described above, appearance may be degraded, and when the softening point of the silicone modified toughening agent is greater than the range described above, bending properties may be reduced.

The powder coating composition according to the present invention may include 3 to 15 wt %, for example 5 to 10 wt %, of the silicone modified toughening agent with respect to a total weight of the composition. When the content of the silicone modified toughening agent is less than the range described above, the effect of improving bending properties may not be sufficient, and when the content of the silicone modified toughening agent is greater than the range described above, appearance and adhesion may be degraded.

### Curing Agent

The powder coating composition according to the present invention includes a curing agent. As the curing agent, at least one selected from the group consisting of a phenol-based curing agent, a dicyandiamide-based curing agent, a hydrazide-based curing agent, phthalic anhydride, trimellitic anhydride, pyromellitic anhydride, benzophenone tetracarboxylic anhydride, and a mixture thereof may be used. For example, a phenol-based curing agent or a dicyandiamide-based curing agent may be used.

Non-limiting examples of the phenol-based curing agent include a resol type phenol-based resin, a novolac type phenol-based resin, a polyhydroxystyrene resin, and the like. Examples of the resol-type phenol-based resin include an aniline modified resol resin, a melamine modified resol resin, and the like. Examples of the novolac type phenol-based resin include a phenol novolac resin, a cresol novolac resin, a tert-butylphenol novolac resin, a nonylphenol novolac resin, a naphthol novolac resin, a dicyclopentadiene modified phenolic resin, a terpene modified phenol-based resin, a triphenol methane type resin, a naphthol aralkyl resin, and the like. Examples of the polyhydroxystyrene resin include poly(p-hydroxystyrene), and the like.

The powder coating composition according to the present invention may include 1 to 30 wt %, for example, 1 to 10 wt %, of the curing agent with respect to a total weight of the composition. When the curing agent is added in an amount above the ranges, a coating film may exhibit reduced mechanical properties. When the content of the curing agent is less than the range described above, a coating film may have reduced strength due to a decrease in crosslinking density, and when the content of the curing agent is greater than the range described above, a coating film may have rapidly increased crosslinking density, which may result in reduced processability.

### Filler

The powder coating composition according to the present invention includes a filler. The filler may include an inorganic filler, a metal filler, or a mixture thereof.

Non-limiting examples of the inorganic filler include feldspar, barium sulfate, silica, alumina hydroxide, titanium dioxide, calcium carbonate, magnesium carbonate, alumina, mica, olastonite, talc, and the like. These may be used alone or in a combination of two or more.

The powder coating composition according to the present invention may include 1 to 50 wt % of the inorganic filler with respect to a total weight of the composition. When the inorganic filler is added in an amount above the ranges, a coating film may exhibit reduced mechanical properties. When the content of the inorganic filler is less than the range described above, mechanical properties may be poor, and when the content of the inorganic filler is greater than the range described above, properties such as bending resistance may be reduced.

Non-limiting examples of the metal filler include potassium, calcium, sodium, magnesium, aluminum, zinc, and an oxide thereof. These may be used alone or in a combination of two or more.

The powder coating composition according to the present invention may include 1 to 30 wt % of the metal filler with respect to a total weight of the composition. When the metal filler is added in an amount above the ranges, a coating film may exhibit reduced corrosion resistance and mechanical properties. When the content of the metal filler is less than the range described above, corrosion resistance may be poor, and when the content of the metal filler is greater than the range described above, a coating may have increased specific gravity, which may result in poor workability.

### Curing Aid

The powder coating composition according to the present invention may further include a curing aid. The curing aid may improve reaction speed between an epoxy resin and a curing agent, thereby reducing curing time.

Non-limiting examples of the curing aid usable in the present invention may include imidazoles, imidazole modified epoxy resins, DBU, DBU salts, triphenylphosphine, metal chelates, and the like. These may be used alone or in a combination of two or more. For example, imidazoles such as 1-methylimidazole, 2-methylimidazole, 1,2-dimethylimidazole, 1,5-dimethylimidazole, 2-butyl-5-chloro-1H-imidazole-4-carbaldehyde, vinylimidazole, climbazole, 1,1-carbonyldiimidazole, tert-butyl dimethylsilyl chloride, 2-ethyl-4-methylimidazole, 2-phenylimidazole, 2-ethylimidazole, 1-benzyl-2-methylimidazole, and 2-butylimidazole may be used.

The powder coating composition according to the present invention may include 0.01 to 1 wt % of the curing aid with respect to a total weight of the composition. When the content of the curing aid is within the range described above, excellent workability and mechanical properties of a coating film may be secured.

### Pigment

The powder coating composition according to the present invention may further include a pigment commonly used in the powder coating field within a range that does not impair the inherent characteristics of the composition.

The pigment may be used to impart a desired color to a powder coating or to increase the strength or gloss of a coating film. As the pigment, organic pigments, inorganic pigments, metallic pigments, AI-paste, pearl, and the like may be used, and these may be used alone or in a combination of two or more. Non-limiting examples of the pigment, which may be used, include azo-based, phthalocyanine-based, iron oxide-based, cobalt-based, carbonate-based, sulfate-based, silicate-based, chromate-based pigments, and the like, for example, titanium dioxide, zinc oxide, bismuth vanadate, cyanine green, carbon black, iron oxide, iron sulfur oxide, navy blue, cyanine blue, and a mixture of two or more thereof. For example, the pigment may be titanium dioxide.

The composition according to the present invention may include 1 to 50 wt % of the pigment with respect to a total weight of the powder coating composition. When the content of the pigment is within the range described above, a coating film may have excellent color expression and improved concealing properties and mechanical properties.

### Additive

The powder coating composition according to the present invention may further include an additive commonly used in the powder coating field within a range that does not impair the inherent characteristics of the composition.

Non-limiting examples of the additive, which may be used in the present invention, include a pinhole inhibitor, a leveling agent, wax, a low-stressing agent, a dispersant, a flowability improver, an anti-cratering agent, a coupling agent, a gloss control agent, an adhesion improver, a flame retardant, a matting agent, a light absorber, and the like. These may be used alone or in a combination of two or more.

The flowability improver is used to prevent cratering and reduce the surface tension of a coating film to achieve a flexible appearance, and a typical agent known in the related art may be used. For example, acrylic-based or silicone-based flowability improvers may be used. The content of the flowability improver is not particularly limited and may be 0.1 to 5 wt % with respect to a total weight of the powder coating composition. When the content of the flowability improver is out of the range described above, flowability may be reduced.

The wax facilitates dispersion during the manufacture of a powder coating and serves as a coating film surface modifier. As the wax, an amide-based, polypropylene-based, olefin-based, or Teflon-based wax may be used.

The powder coating composition according to the present invention may be prepared through methods known in the related art. For example, the above-described component raw materials of the powder coating composition may be blended and uniformly mixed using a container mixer, and the mixed composition may be melt-mixed using a kneader or an extruder at 80 to 120° C., and then a powder coating may be prepared using a pulverizer.

An average particle size of the powder coating is not particularly limited, but may be, for example, 20 to 80 μm. When the average particle size of the powder coating is within the above range, excellent coating workability and appearance characteristics may be exhibited.

A coating film using the powder coating composition according to the present invention may be formed through a method known in the related art. For example, while a steel pipe basis material in which a primer is blasted in advance is preheated at a temperature of 180 to 250° C., the powder coating composition according to the present invention is applied to a thickness of 200 to 500 μm using an electrostatic spray coating machine, and then the steel pipe basis material is heated at a temperature of 180 to 250° C. for 1 to 5 minutes to form a coating film, and then the coating film is immediately immersed in cold water to form a final coating film.

The powder coating composition according to the present invention may form a coating film exhibiting excellent heat resistance, adhesion, bending properties, and corrosion resistance even in a high-temperature/high-pressure environment. Therefore, the powder coating composition according to the present invention may be used as a powder coating for pipe required for transporting high-temperature fluids.

### MODE FOR CARRYING OUT THE INVENTION

Hereinafter, the present invention will be described in more detail through Experimental Examples. However, Experimental Examples shown below are illustrated only for the understanding of the present invention, and the scope of the present invention is not limited thereto in any sense.

### Examples 1 to 14

According to Tables 1 and 2 below, each component raw material was blended and mixed uniformly using a container mixer. The mixed composition was melted and mixed using a kneader at 100° C., and then a powder coating composition of each Example, having an average particle size of 50 μm, was prepared using a pulverizer.

### Comparative Examples 1 and 2

Powder coating compositions of each Comparative Example were prepared in the same manner as in Examples, except that compositions shown in Table 3 were used.

TABLE 1

| | Component (parts by weight) | | | | | | |
|---|---|---|---|---|---|---|---|
| | Ex. 1 | Ex. 2 | Ex. 3 | Ex. 4 | Ex. 5 | Ex. 6 | Ex. 7 |
| Epoxy resin 1 | 56.9 | | | | | 50 | 70 |
| Epoxy resin 2 | | 56.9 | | | | | |
| Epoxy resin 3 | | | 56.9 | | | | |
| Epoxy resin 4 | | | | 56.9 | | | |
| Epoxy resin 5 | | | | | 56.9 | | |
| Toughening | 9.1 | 9.1 | 9.1 | 9.1 | 9.1 | 10 | 10 |
| agent 1 | | | | | | | |
| Toughening | | | | | | | |
| agent 2 | | | | | | | |
| Toughening | | | | | | | |
| agent 3 | | | | | | | |
| Toughening | | | | | | | |
| agent 4 | | | | | | | |
| Toughening | | | | | | | |
| agent 5 | | | | | | | |
| Toughening | | | | | | | |
| agent 6 | | | | | | | |
| Curing agent | 1.5 | 1.5 | 1.5 | 1.5 | 1.5 | 1.6 | 1.6 |
| Curing aid | 0.2 | 0.2 | 0.2 | 0.2 | 0.2 | 0.2 | 0.2 |
| Inorganic filler | 21.3 | 21.3 | 21.3 | 21.3 | 21.3 | 26.1 | 6.1 |
| Metal filler | 7.1 | 7.1 | 7.1 | 7.1 | 7.1 | 7.8 | 7.8 |
| Color pigment | 3.5 | 3.5 | 3.5 | 3.5 | 3.5 | 3.9 | 3.9 |
| Flowability | 0.4 | 0.4 | 0.4 | 0.4 | 0.4 | 0.4 | 0.4 |
| improver | | | | | | | |

TABLE 2

| | Component (parts by weight) | | | | | | |
|---|---|---|---|---|---|---|---|
| | Ex. 8 | Ex. 9 | Ex. 10 | Ex. 11 | Ex. 12 | Ex. 13 | Ex. 14 |
| Epoxy resin 1 | 56.9 | 56.9 | 56.9 | 56.9 | 56.9 | 56.9 | 56.9 |
| Epoxy resin 2 | | | | | | | |
| Epoxy resin 3 | | | | | | | |
| Epoxy resin 4 | | | | | | | |
| Epoxy resin 5 | | | | | | | |
| Toughening | | | | | | 5 | 10 |
| agent 1 | | | | | | | |
| Toughening | 9.1 | | | | | | |
| agent 2 | | | | | | | |
| Toughening | | 9.1 | | | | | |
| agent 3 | | | | | | | |
| Toughening | | | 9.1 | | | | |
| agent 4 | | | | | | | |
| Toughening | | | | 9.1 | | | |
| agent 5 | | | | | | | |
| Toughening | | | | | 9.1 | | |
| agent 6 | | | | | | | |
| Curing agent | 1.5 | 1.5 | 1.5 | 1.5 | 1.5 | 1.5 | 1.5 |
| Curing aid | 0.2 | 0.2 | 0.2 | 0.2 | 0.2 | 0.2 | 0.2 |
| Inorganic filler | 21.3 | 21.3 | 21.3 | 21.3 | 21.3 | 25.4 | 20.4 |
| Metal filler | 7.1 | 7.1 | 7.1 | 7.1 | 7.1 | 7.1 | 7.1 |
| Color pigment | 3.5 | 3.5 | 3.5 | 3.5 | 3.5 | 3.5 | 3.5 |
| Flowability | 0.4 | 0.4 | 0.4 | 0.4 | 0.4 | 0.4 | 0.4 |
| improver | | | | | | | |

TABLE 3

| | Comparative | Comparative |
|---|---|---|
| Component (parts by weight) | Example 1 | Example 2 |
| Epoxy resin 1 | 56.9 | 56.9 |
| Toughening agent 7 | | 9.1 |
| Curing agent | 1.5 | 1.5 |
| Curing aid | 0.2 | 0.2 |
| Inorganic filler | 30.4 | 21.3 |
| Metal filler | 7.1 | 7.1 |
| Color pigment | 3.5 | 3.5 |
| Flowability improver | 0.4 | 0.4 |

Epoxy resin 1: Bisphenol A diglycidyl ether (BADGE) (epoxy equivalent: 420 g/eq)
Epoxy resin 2: Bisphenol A diglycidyl ether (BADGE) (epoxy equivalent: 600 g/eq)
Epoxy resin 3: Bisphenol A diglycidyl ether (BADGE) (epoxy equivalent: 780 g/eq)
Epoxy resin 4: Bisphenol F epoxy resin (epoxy equivalent: 550 g/eq)
Epoxy resin 5: Polyol modified epoxy resin (epoxy equivalent: 690 g/eq)
Toughening agent 1: Compound of Formula 1 (R₁=—OCH₂CH₂CH₃, R₂-ethylene oxide oligomer, n=4, m=12, silicon content: 40 wt %)
Toughening agent 2: Compound of Formula 1 (R₁=—OCH₂CH₂CH₃, R₂=propylene oxide oligomer, n=6, m=15, silicon content: 40 wt %)
Toughening agent 3: Compound of Formula 1 (R₁=—OCH₂OCH₃, R₂=ethylene oxide oligomer, n=5, m=14, silicon content: 40 wt %)
Toughening agent 4: Compound of Formula 1 (R₁=—OCH₂OCH₃, R₂=propylene oxide oligomer, n=8, m=16, silicon content: 40 wt %)
Toughening agent 5: Compound of Formula 1 (R₁=—OCH₂CH₂CH₃, R₂=ethylene oxide oligomer, n=9, m=18, silicon content: 33 wt %)
Toughening agent 6: Compound of Formula 1 (R₁=—OCH₂CH₂CH₃, R₂=ethylene oxide oligomer, n=4, m=20, silicon content: 75 wt %)
Toughening agent 7: Polyether tri block copolymer
Curing agent: Dicyandiamide
Curing aid: 2-MI (2-METHYLIMIDAZOLE)
Inorganic filler: MF200 (Buyeo Material Co.)
Metal filler: Aluminum oxide (LK Inter)
Color pigment: Bayferrox 130M (Bayer)
Flowability improver: Silicon dioxide

### Experimental Example—Evaluation of Properties

Properties of the powder resin compositions prepared in each of Example and Comparative Example were determined through the following method, and the results are shown in Tables 4 to 6 below.

### Glass Transition Temperature

Glass transition temperature was measured using a differential scanning calorimeter.

### Bending Resistance

A steel of 25 mm (width)×300 mm (length)×6 mm (thickness) was prepared, and subjected to grit blasting surface treatment. The surface treated steel was preheated to 230° C., and then the powder coating compositions according to each of Example and Comparative Example were applied onto the steel surface through electrostatic spraying to achieve a coating film thickness of 350 μm, thereby preparing specimens.

Thereafter, temperature of the specimens were set to room temperature, 0° C., and −5° C., and when the specimens were bent using a mandrel adjusted to an angle of 3° and 2°, the presence or absence of crack of a coating film was examined.

### [Evaluation Standard]

o: No crack, X: Crack observed

### Impact Resistance

Temperature of specimens prepared in the same manner as in the bending resistance test was set to 10° C., and an impact of 3 J/g was applied to determine damage from the impact applied through a holiday tester.

### [Evaluation Standard]

o: No damage, X: Damage observed

### Boiling Water Resistance (Hot Water Immersion)

A steel of 100 mm (width)×100 mm (length)×6 mm (thickness) was prepared, and subjected to grit blasting surface treatment. The surface treated steel was preheated to 230° C., and then the powder coating compositions according to each of Example and Comparative Example were applied onto the steel surface through electrostatic spraying to achieve a coating film thickness of 350 μm, thereby preparing specimens.

Thereafter, the specimens were immersed in a water bath at 75° C. and taken out after 28 days to evaluate adhesion. The taken out specimens were cooled to room temperature for 1 hour, and then a rectangular shape of 15 mm in width and 30 mm in length was scraped with a knife until a basis material is exposed, the knife was pushed between the coating film and the basis material around the exposed portion of the basis material to measure adhesion using the principle of the lever, and then evaluate ratings according to a delaminated area.

### [Evaluation Standard]

Rating 1: No delamination
Rating 2: Less than 50% delamination
Rating 3: At least 50% delamination
Rating 4: Easily delaminated into large piece
Rating 5: Easily delaminated into one piece at a time

### Cathodic Disbondment Resistance

Specimens were prepared using in the same manner as in the bending resistance test, but the steel was prepared in a size of 100 mm (width)×100 mm (length)×6 mm (thickness). Thereafter, a hole having a diameter of 3 mm was punched in the center of the specimen, a 3% concentration of brine was added to contact a coating film surface, evaporation was prevented using a container, and then, a voltage of 1.5 V was applied to the basis material at 130° C. for 28 days to measure disbondment distance from the hole 2 times. It may be interpreted that the greater the disbondment distance, the lower the adhesion of the powder coating composition to the basis material. The specimen preparation and property evaluation were performed in accordance with CSA Z245.20, a Canadian standard for pipes.

TABLE 4

| Properties | | Ex. 1 | Ex. 2 | Ex. 3 | Ex. 4 | Ex. 5 | Ex. 6 | Ex. 7 |
|---|---|---|---|---|---|---|---|---|
| DSC | Tg (° C.) | 157 | 153 | 162 | 155 | 156 | 156 | 156 |
| Bending | R.T. | ∘ | ∘ | ∘ | ∘ | ∘ | ∘ | ∘ |
| resistance | *3°/PD | | | | | | | |
| | 0° C.*3°/ | ∘ | ∘ | ∘ | ∘ | ∘ | ∘ | ∘ |
| | PD | | | | | | | |
| | −5° C.*2°/ | ∘ | ∘ | ∘ | ∘ | ∘ | ∘ | ∘ |
| | PD | | | | | | | |
| | −5° C.*3°/ | ∘ | ∘ | ∘ | ∘ | ∘ | ∘ | ∘ |
| | PD | | | | | | | |
| Impact resistance | 10° C.*3 J/g | ∘ | ∘ | ∘ | ∘ | ∘ | ∘ | ∘ |
| Boiling water | 75° C.*28 | 1 | 1 | 1 | 1 | 1 | 1 | 1 |
| resistance | days | | | | | | | |
| | (rating) | | | | | | | |
| Cathodic | 1 time | 7.5 | 7.9 | 7.8 | 7.7 | 7.6 | 7.6 | 7.8 |
| disbondment | (mm) | | | | | | | |
| (1.5 V*130° | 2 times | 7.9 | 8 | 8.1 | 8 | 8 | 8 | 8.1 |
| C.*28 d) | (mm) | | | | | | | |

TABLE 5

| Properties | | Ex. 8 | Ex. 9 | Ex. 10 | Ex. 11 | Ex. 12 | Ex. 13 | Ex. 14 |
|---|---|---|---|---|---|---|---|---|
| DSC | Tg (° C.) | 155 | 155 | 156 | 156 | 155 | 155 | 156 |
| Bending | R.T. | ∘ | ∘ | ∘ | ∘ | ∘ | ∘ | ∘ |
| resistance | *3°/PD | | | | | | | |
| | 0° C.*3°/ | ∘ | ∘ | ∘ | ∘ | ∘ | ∘ | ∘ |
| | PD | | | | | | | |
| | −5° C.*2°/ | ∘ | ∘ | ∘ | ∘ | ∘ | ∘ | ∘ |
| | PD | | | | | | | |
| | −5° C.*3°/ | ∘ | ∘ | ∘ | ∘ | ∘ | ∘ | ∘ |
| | PD | | | | | | | |
| Impact resistance | 10° C.*3 J/g | ∘ | ∘ | ∘ | ∘ | ∘ | ∘ | ∘ |
| Boiling water | 75° C.*28 | 1 | 1 | 1 | 1 | 1 | 1 | 1 |
| resistance | days | | | | | | | |
| | (rating) | | | | | | | |
| Cathodic | 1 time | 7.6 | 7.6 | 7.9 | 7.8 | 7.7 | 7.8 | 7.7 |
| disbondment | (mm) | | | | | | | |
| (1.5 V*130° | 2 times | 8 | 8.1 | 8 | 8 | 8.1 | 8.1 | 8 |
| C.*28 d) | (mm) | | | | | | | |

TABLE 6

| | | Comparative | Comparative |
|---|---|---|---|
| Properties | | Example 1 | Example 2 |
| DSC | Tg (° C.) | 158 | 152 |
| Bending | R.T. *3°/PD | ◯ | ◯ |
| resistance | 0° C.*3°/PD | X | ◯ |
| | −5° C.*2°/PD | X | ◯ |
| | −5° C.*3°/PD | X | ◯ |
| Impact resistance | 10° C.*3 J/g | X | X |
| Boiling water | 75° C.*28 days | 2 | 2 |
| resistance | (rating) | | |
| Cathodic | 1 time (mm) | 10.9 | 8.4 |
| disbondment | 2 times (mm) | 9.8 | 8.3 |
| (1.5 | | | |
| V*130° C.*28 d) | | | |

As shown in Tables 4 to 6, the powder coating compositions of Examples 1 to 14 according to the present invention were found to exhibit excellent effects in all measured properties. Conversely, the powder coating composition of Comparative Example 1 that did not include a toughening agent was found to be inferior to Examples in overall properties, and the powder coating composition of Comparative Example 2 that used a polyether triblock copolymer instead of a silicone modified toughening agent was found to be inferior to Examples in impact resistance, boiling water resistance, and cathodic disbondment resistance.

### INDUSTRIAL APPLICABILITY

A powder coating composition according to the present invention maintains excellent adhesion, thermal stability, and mechanical properties of epoxy-based coatings while overcoming the limitation of brittleness, thereby providing excellent flexibility, appearance, and corrosion resistance without a reduction in the glass transition temperature of a final cured product. The powder coating composition according to the present invention may form a coating film exhibiting excellent heat resistance, adhesion, bending properties, and corrosion resistance even in a high-temperature/high-pressure environment. Therefore, the powder coating composition according to the present invention may be used as a powder coating for pipe required for transporting high-temperature fluids.

1. A powder coating composition comprising an epoxy resin, a silicone modified toughening agent, a curing agent, and a filler.

2. The powder coating composition of claim 1, wherein the epoxy resin comprises a bisphenol A type epoxy resin, a bisphenol F type epoxy resin, a polyol modified epoxy resin, or a mixture thereof, and
the bisphenol A type epoxy resin, the bisphenol F type epoxy resin, and the polyol modified epoxy resin each have an epoxy equivalent of 200 to 1,000 g/eq.

3. The powder coating composition of claim 1, wherein the epoxy resin comprises a novolac modified epoxy resin, a cresol novolac epoxy resin, or a mixture thereof, and
the novolac modified epoxy resin and the cresol novolac epoxy resin each have an epoxy equivalent of 100 to 1,500 g/eq.

4. The powder coating composition of claim 1, wherein the silicone modified toughening agent has a silicone content of 30 to 80 wt % with respect to a total amount of the toughening agent.

5. The powder coating composition of claim 1, wherein the silicone modified toughening agent is a compound represented by Formula 1 below: 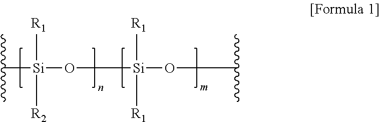
wherein in Formula 1 above,
R₁ is —H, —CH₃, —C₆H₆, —OCH₃, —OCH₂OCH₃, or —OCH₂CH₂CH₃,
R₂ is an alkylene oxide oligomer,
n is an integer between 1 and 10, and
m is an integer between 5 and 20.

6. The powder coating composition of claim 1, wherein the silicone modified toughening agent has a weight average molecular weight of 5,000 to 20,000 g/mol.

7. The powder coating composition of claim 1, comprising 45 to 75 wt % of the epoxy resin, 3 to 15 wt % of the silicone modified toughening agent, 1 to 30 wt % of the curing agent, and 1 to 50 wt % of an inorganic filler, and 1 to 30 wt % of a metal filler, with respect to a total weight of the composition.
